(19) United States
(12) Patent Application Publication
(10) Pub. No.: US 2013/0321125 A1
(43) Pub. Date: Dec. 5, 2013

(54) DELAYED EGRESS DEVICE OR LOCK WITH ENHANCED VISIBILITY

(71) Applicants: Arthur V. Geringer, Oak Park, CA (US); David A. Geringer, Camarillo, CA (US); Richard Geringer, Moorpark, CA (US)

(72) Inventors: Arthur V. Geringer, Oak Park, CA (US); David A. Geringer, Camarillo, CA (US); Richard Geringer, Moorpark, CA (US)

(21) Appl. No.: 13/887,149

(22) Filed: May 3, 2013

Related U.S. Application Data
(60) Provisional application No. 61/642,270, filed on May 3, 2012.

(51) Int. Cl. E05B 65/10

(52) U.S. Cl. CPC E05B 65/108
USPC 340/5.28; 292/251.5

(57) ABSTRACT

A delayed egress locking device that has an improved illumination system that signals when the lock is actuated. The illumination system can also signal the stages of conditions in a delayed egress sequence. The locking device is also directed to a security system for securing a door, wherein egress through the door is delayed for a time interval once the locking device is actuated. The locking device can also include a timing device, wherein the timing device can measure a time interval following the actuation of the locking device. The locking device can also include an illumination system, which can comprise light sources, that displays a countdown when the locking device is actuated, as well as an audio system which alerts when the locking device is actuated.

### CROSS REFERENCE TO RELATED APPLICATIONS

This application claims the benefit of U.S. Provisional Patent Application Ser. No. 61/642,270, to Geringer et al., filed on May 3, 2012, and entitled “Delayed Egress Device or Lock with Enhanced Visibility.”

### BACKGROUND OF THE INVENTION

1. Field of the Invention

The present invention relates to security systems for doors, and in particular to providing improved warning and visibility for electrically operable delayed egress devices and electrically operable magnetic locks.

2. Description of the Related Art

Security doors have evolved over the years from simple doors with heavy duty locks to sophisticated egress and access control devices. Many years ago, heavy duty chains and locks were the norm on security doors which were not generally used, or which were used to prevent theft or vandalism. However, fire codes have made such relatively simple door locking systems obsolete. Emergency exit doors are required by law to be provided in all commercial buildings, and such doors must be operative in the event of a fire, earthquake, or other emergency.

These exit doors are typically provided with heavy horizontal push bars, which unlock the door upon actuation and which may provide an alarm of some sort. The early alarms on such doors were either mechanical in nature, such as wind-up alarms contained on the push bar mechanism, or completely separate electrical circuits actuated by a switch opened as the door was opened. Accordingly, egress from such doors was immediate, and, although egress was accompanied by an alarm, typically the person leaving through the door was long gone by the time security personnel arrived.

Many businesses can suffer great losses through emergency doors, with thieves escaping cleanly through the emergency doors with valuable merchandise. In addition, industrial companies also suffer pilferage of valuable equipment and merchandise through such emergency exit doors. While one solution is to have a greater number of security personnel patrolling the emergency exit doors, to do so is also an expensive solution.

Over the past several decades a number of devices have been developed which attempted to address this problem. A series of such devices is found in U.S. Pat. No. 4,257,631, U.S. Pat. No. 4,328,985, U.S. Pat. No. 4,354,699, U.S. Pat. No. 4,652,028, and U.S. Pat. No. 4,720,128, all to Logan, Jr. or Logan, Jr. at al. The Logan, Jr. patents begin with the Logan, Jr. '631 patent, which describes a system activated by a push bar which, upon depression, moves a switch carried by the door to sound an alarm and start a timer delay. After the delay, the door is unlocked.

The Logan '985 patent teaches a hydraulic system for accomplishing the delay prior to unlocking the door, and the Logan '699 patent describes a retrofit locking device of the same type, but usable with any door latching system. The Logan et al. '028 patent and the Logan, Jr. et al. '128 patent both teach an electromagnet mounted on a door jamb, an armature on the door held by the electromagnet to retain the door in the closed position, and a switch used to indicate when the door is being opened or tampered with. The Logan, Jr. et al. '128 patent adds a set of contacts to confirm that the armature properly contacts the electromagnet.

U.S. Pat. No. 4,439,808, to Gillham, describes another system which also uses an armature on a door and an electromagnet on the door jamb. The armature has shoulders to retain the door in the closed position even if someone exerts enough pressure on the door to otherwise slide the armature off of the electromagnet. U.S. Pat. No. 4,439,808, to Gillham, is hereby incorporated herein in its entirety by reference.

Other innovative devices were developed that are reflected in U.S. Pat. No. 4,609,910 and U.S. Pat. No. 5,000,497, both to Geringer et al., the inventors of the present invention. The Geringer et al. '910 patent teaches a system with an armature on a door, an electromagnet on a door jamb, and a switch used to indicate when an attempt is made to open the door. The Geringer et al. '497 patent teaches a novel door-mounted armature and door jamb-mounted electromagnet. U.S. Pat. No. 4,609,910 and U.S. Pat. No. 5,000,497 are both hereby incorporated herein in their entirety by reference.

The inventors in the present invention also developed an innovative delayed egress locking system as shown in U.S. Pat. No. 5,429,399, which is hereby incorporated herein in its entirety by reference. This system provides a security system for use on doors which have an electrically operated door locking mechanism. The security system is operative to provide a preset egress time delay following an effort to exit through the controlled door before actuating the door locking mechanism to unlock the door and allow egress. During the egress time delay, the system provides a visual input of the time remaining until the door locking mechanism will unlock the door to allow egress or access there through. In the preferred embodiment, a speech synthesizer and digital display is also utilized to inform the individual demanding egress or access of the delay, and to provide other information as desired.

Some delayed egress locks can use an audible countdown to indicate when a door will open once it is actuated or may include a siren as a further indication that attention is needed at the opening. However, in some “quiet” locations such as hospitals or assisted living facilities these audible signals are often softened or turned off altogether. In high noise environments such as airports or warehouses, external strobe lights are often added to draw attention to the alarmed door or opening. These indicators can be visually unpleasant, and can also have deleterious effects on those who suffer from disorders such as epilepsy.

### SUMMARY OF THE INVENTION

The present invention provides an improvement over previous locking and delayed egress systems. In particular the present invention provides for improved visibility for the operation of electrically operable delayed egress devices and electrically operable locks. Existing magnetic locks or delayed egress devices can rely on a visual indicator consisting of a small LED or a narrow illuminated strip. In some applications, this may not be enough of a visual cue to personnel that a door has been actuated, opened or that tampering has occurred.

The present invention is directed to a magnetic locking device or delayed egress locking device (“locking device”) that can comprise an improved illumination system or visual indicator system triggered when the lock is actuated. In some embodiments, the illumination system can comprise a series of light sources that are actuated in different ways to not only alert as to when a locking device has been actuated, but also to signal the stages of door conditions in delayed egress sequences such as those provided in delayed egress locking devices. In different embodiments the lighting system can comprise a series of built-in solid state lamps (LED or backlit LCD), displays or indicators for the purpose of improving visibility of the device to visually signal personnel of an emergency, abnormal event, or that someone has opened the door and possibly entered or exited. The present invention can also provide the advantage of illuminating the area around the door to provide for safer passage through the doorway.

The present invention is also directed to a security system which can comprise a locking device for securing a door, wherein egress through the door is delayed for a time interval once the locking device is actuated. The present invention can also comprise a timing device connected to the locking device, wherein the timing device indicates a period or portion of the time interval once said locking device is actuated. Also, the present invention can comprise an illumination system connected to the locking device, wherein the illumination system comprises a series of light sources that signal when the locking device is actuated. The illumination system can also comprise light sources or light indicators that enhance the ability of the illumination system to signal when the locking device has been actuated. The locking device can also be connected to a switch, wherein the switch sends a signal to the timing device and the illumination system when the locking device is actuated. The present invention can further comprise an audio source that can sound an audible signal when the locking device has been actuated. The illumination system and the audio source can act as alarm sources for the locking device.

These and other further features and advantages of the invention will be apparent to those skilled in the art from the following detailed description, taken together with the accompanying drawings, in which:

### BRIEF DESCRIPTION OF THE DRAWINGS

FIG. 1 is a perspective view of one embodiment of a lighting system housing according to the present invention;

FIG. 2 is a first side view of the lighting system housing shown in FIG. 1;

FIG. 3 is top view of the lighting system housing shown in FIG. 1;

FIG. 4 is a second side view of the lighting system housing shown in FIG. 1;

FIG. 5 is a sectional view of the lighting system housing shown in FIG. 1, taken along section lines A-A of FIG. 3;

FIG. 6 is another sectional view of the lighting system housing in FIG. 1, taken along section lines B-B of FIG. 3;

FIG. 7 is an expanded perspective view showing one embodiment of a lighting system according to the present invention mounted to a locking device;

FIG. 8 is an end view of the locking device and lighting system shown in FIG. 7;

FIG. 9 is a front view of one embodiment of a locking device with a lighting system according to the present invention;

FIG. 10 is a front view of one embodiment of a locking device with a lighting system according to the present invention mounted to a door;

FIG. 11 is a perspective view of another embodiment of a lighting system housing according to the present invention;

FIG. 12 is a first side view of the lighting system housing shown in FIG. 11;

FIG. 13 is a top view of the lighting system housing shown in FIG. 11;

FIG. 14 is a second side view of the lighting system housing shown in FIG. 11;

FIG. 15 is a sectional view of the lighting system housing shown in FIG. 11, taken along section lines A-A of FIG. 13;

FIG. 16 is another sectional view of the lighting system housing in FIG. 11, taken along section lines B-B of FIG. 13;

FIG. 17 is one embodiment of a digital display according to the present invention as showing when the door is locked;

FIG. 18 shows the digit display in FIG. 17 as it appears when the door is unlocked but unopened;

FIG. 19 shows the digital display in FIG. 17 as it appears when the door is unlocked and has been opened;

FIG. 20 is a front view of another embodiment of a locking device with a lighting system according to the present invention; and

FIG. 21 is an annunciation bar for a locking device according to the present invention.

### DETAILED DESCRIPTION OF THE INVENTION

Different embodiments of the present invention are directed to improved lighting and indicator systems for locking devices. In some embodiments, the indicators or light sources can comprise multiple LEDs or displays arranged in a pattern or grid. The LEDs or displays can comprise multiple colors to indicate a selectable or rolling sequence, and varying color and/or intensity of each individual LED or pixel in a display can reflect different conditions of the locking device and can also create the illusion of motion and enhance visibility. When a grid pattern of lamps or pixels are employed, graphical symbols, pictures or text may be displayed to deliver information to those in close vicinity and to further enhance the visual appearance from a distance. The increased level of light generated by the array or grid can also be used to partially illuminate the opening during an alarm condition making it stand out from the other nearby secure openings. The indicators or light sources of the present invention can also comprise a liquid crystal display (LCD) panel. The indicators or light sources can function as signals to notify if the locking device has been actuated or the door has been opened. These signals can comprise light patterns or visual messages. Furthermore, the present invention can comprise an audio source that audibly notifies when the locking device has been actuated or the door has been opened.

Some embodiments can comprise retrofit systems for existing locking devices, with some embodiments consisting of an opaque or translucent housing that mounts to the locking device. Other embodiments can comprise the entire cover or housing of the lock itself, which can comprise an opaque or translucent material with the lighting system emitting through the translucent material or through openings in the opaque material. Utilizing the entire housing can facilitate a greater surface area to illuminate or be used to display graphics or text. Other embodiments can include other features such as a sensor and/or an indicator to notify if the door has been opened following the delayed egress sequence. This can provide an indication of whether a person may have passed through the door at the end of the sequence. As such, the locking device can communicate with the door, so that that locking device and the door can function as a security system. Furthermore, the illumincation system, the audio source, and/or the sensor can communicate with the locking device and/or the door. The locking devices according to the present invention can also be equipped with a hidden camera to monitor the activity at the door before, during, and/or after actuation of the locking device, as well as any individual that may actuate the locking device. These embodiments can also comprise wiring or a wireless transmitter to carry the camera signal to a person monitoring the door, such as security personal, or can include other types of sensors such as infrared sensors.

It is understood that when an element can be referred to as being “on” another element, it can be directly on the other element or intervening elements may also be present. Furthermore, relative terms such as “inner,” “outer,” “upper,” “above,” “lower,” “beneath,” and “below,” and similar terms, may be used herein to describe a relationship of one element to another. It is understood that these terms are intended to encompass different orientations of the device in addition to the orientation depicted in the figures.

Although the ordinal terms first, second, etc., may be used herein to describe various elements, components, regions and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present invention.

As used herein, the term “source” can be used to indicate a single light emitter or more than one light emitter functioning as a single source. For example, the term may be used to describe a single blue LED, or it may be used to describe a red LED and a green LED in proximity emitting as a single source. Thus, the term “source” should not be construed as a limitation indicating either a single-element or a multi-element configuration unless clearly stated otherwise.

Embodiments of the invention are described herein with reference to cross-sectional view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region of a device and are not intended to limit the scope of the invention.

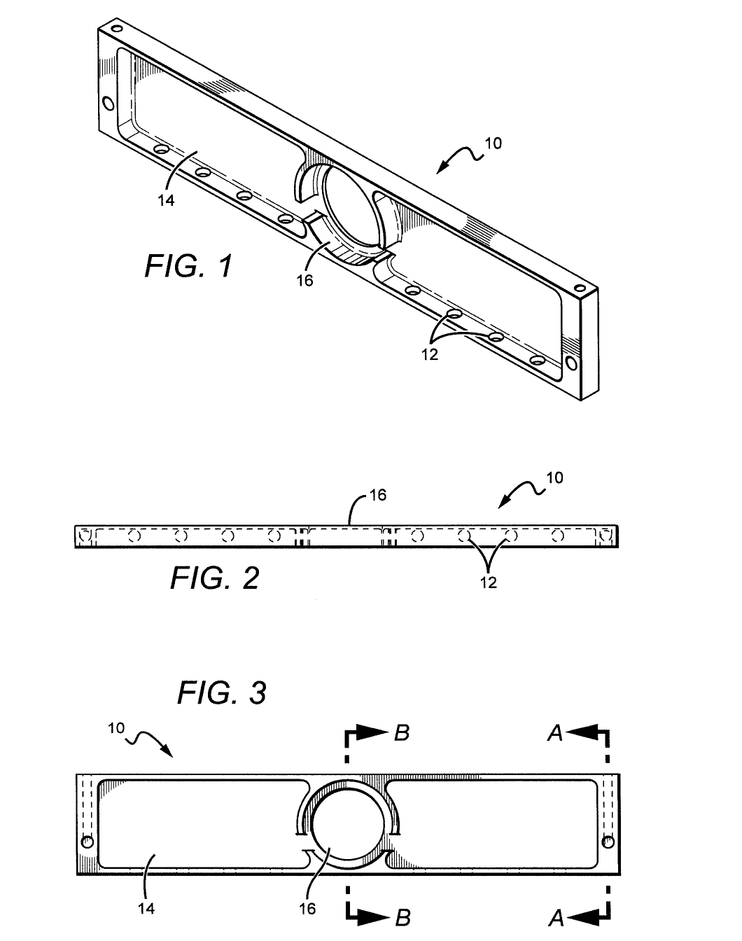

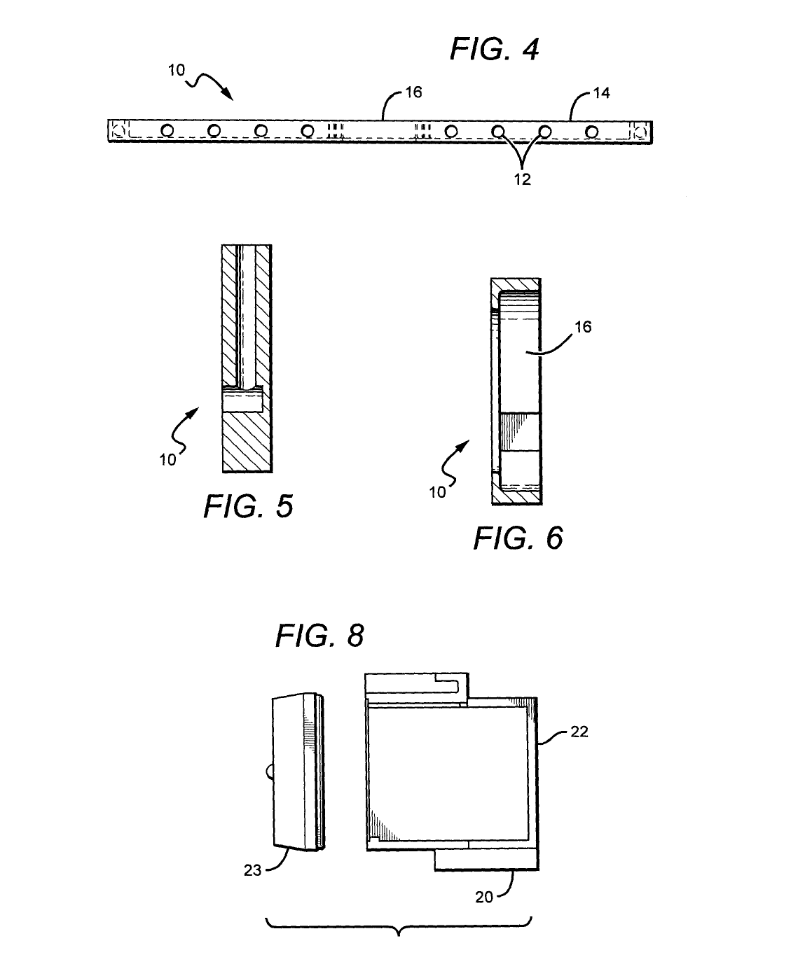

FIGS. 1 through 6 show one embodiment of a locking device lighting system housing 10 according to the present invention that can be sized to fit on a locking device, and in particular a delayed egress device. The locking device according to the present invention can be electric, magnetic, or any other type of locking device. FIG. 1 is a perspective view of one embodiment of a lighting system housing 10 according to the present invention. FIG. 2 is a first side view of the lighting system housing 10. FIG. 3 is top view of the housing. Additionally, FIG. 4 is a second side view of the lighting system housing 10. Furthermore, FIG. 5 is a sectional view of the lighting system housing 10, taken along section lines A-A in FIG. 3. Finally, FIG. 6 is another sectional view of the lighting system housing 10, taken along section lines B-B in FIG. 3.

The housing 10 can have a series of light holes 12 sized to hold light sources, like conventional LEDs (not shown), such that the light sources can emit light out from the housing. The light sources can be electrically connected to the locking device through wiring that enters the housing cavity 14. The light sources can be powered by electricity, batteries, or any other power source. Additionally, the light sources can be located anywhere on the housing and/or locking device, or even at a location remote from the locking device. The light sources can comprise of different types of LEDs that have different colors, such as white, green, yellow, red, blue, or any combination thereof. In some embodiments red, green and blue (RGB) LEDs can be included that are capable of emitting these three colors, or colors that are combinations of these three colors. The housing 10 can have the LEDs mounted along one surface, although it is understood that the LEDs can be mounted on any of the other surfaces such that they emit out of the housing.

The housing 10 can be made of many different materials, such as a plastic or acrylic, and can be opaque, transparent or partially transparent. In some embodiments, the housing 10 can be transparent and can comprise dispersing materials, such as scattering particles, which can disperse light as it emits from the housing 10.

The housing 10 can also have an opening 16 sized to hold a speaker (not shown) which can provide enhanced audible emission from the housing 10. When the housing is mounted to a locking device, the speaker can be directed to the person attempting to open the door, thereby providing a greater chance that the person will hear any signals and/or commands from the locking device, even when in a particularly noisy location. Like the LEDs, the signal to the speaker can be applied by a wire connection to the speaker that can pass through the housing cavity 14. In other embodiments, the speaker can be wirelessly activated.

As mentioned above, a camera or other presence sensing devices can also be mounted to the housing in a way that allows for visual monitoring of the area around the door. The electrical connection to the camera can also pass through the housing cavity 14, with the camera capable of being mounted in many different locations. In some embodiments, the camera can be mounted adjacent to the opening 16, and can be mounted at an angle to provide viewing of the desired area around the door. In other embodiments, the camera can be mounted and angled at greater than 10°, with some embodiments being mounted at any other angle, such as 30°. It is understood that different embodiments of the systems according to the present invention can include many other devices and sensors including but not limited to infrared, ultrasonic, and/or microwave sensors.

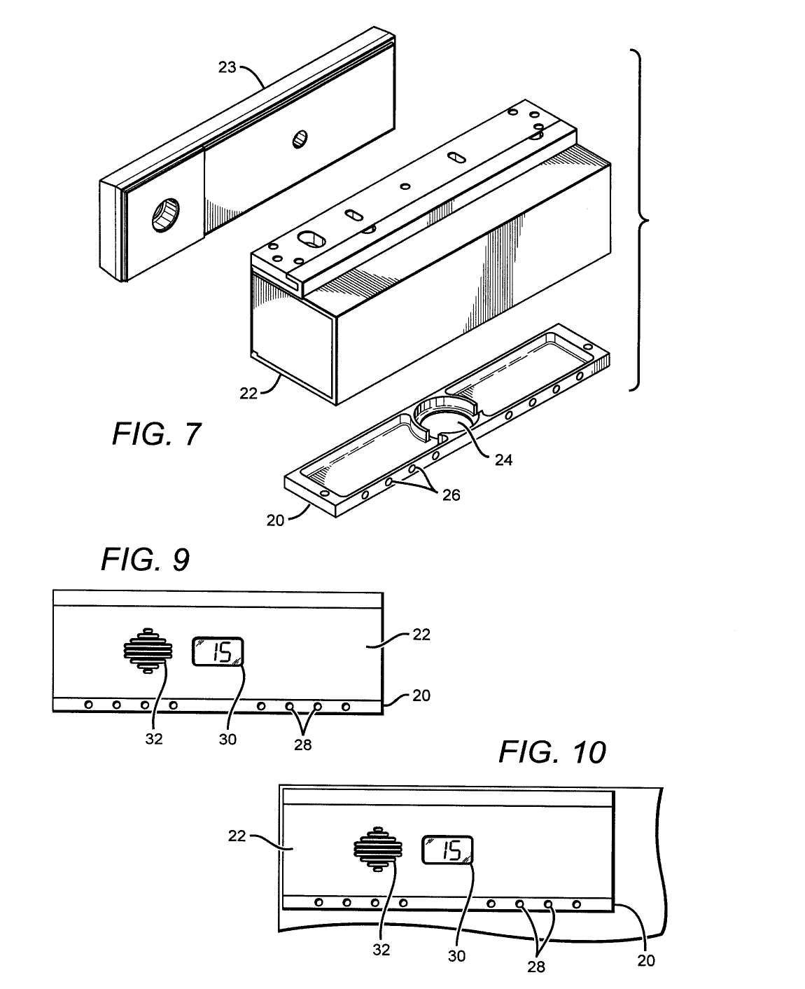

FIGS. 7 and 8 show one embodiment of a lighting system 20 mounted to a locking device 22, which in the embodiment shown comprises a delayed egress locking device. The system 20 can be mounted to the locking device 22 using many know devices and methods, such as screws, bolts, brackets, and/or bonding materials. In the embodiment shown, the system 20 can be mounted to the device 22 using conventional screws. The system 20 can be mounted to many different surfaces of the locking device 22, with the embodiment shown being mounted to the bottom surface of the locking device, with an opening 24 directed down and light holes 26 positioned to direct light outwardly. It is understood that the system can be mounted to any surface of the locking device, and the opening and light holes can be directed in any direction. The locking device 22 can also comprise a mounting device 23. The mounting device 23 can help the locking device 22 mount to a door, a wall, and/or any other surface.

FIGS. 9 and 10 also show the lighting system 20 mounted to the locking device 22. In this embodiment, the lighting system 20 can have light sources 28 that are illuminating. As stated previously, the light sources 28 can comprise LEDs. The locking device 22 can also have a digital display 30 for providing a countdown time interval indicator, which can display indicia indicating the locking device condition when the locking device is actuated until when the door will unlock. In FIGS. 9 and 10, the time interval displayed from locking device actuation until egress is 15 seconds. However, the time interval according to the present invention can comprise any period of time that will delay egress.

The locking device 22 can also have a speaker 32, which can be forward directed, which can act as an audio source. The speaker 32 can provide a number of audible signals to alert when the locking device 22 is actuated or when the door is unlocked and/or opened. The speaker can provide a variety of sounds, including voice commands, sirens, alarms, and/or any other audible signals.

The lighting systems according to the present invention can also emit many different combinations of audible signals and visual patterns from the light sources and digital display that can work together or independent of one another. One embodiment of an LED lighting system according to the present invention can have a 15 second delayed egress sequence that uses the light sources, which can be LEDs, and speakers as follows:

When the delayed egress locking device is actuated, the LEDs are green and an audible beep is emitted. The digital display starts a 15 second time interval that counts down from 15 seconds to 0 seconds.

When the digital display reaches 12 seconds, the LEDs switch to emit yellow light and an audible command “exit in 12 seconds, security has been alerted” is emitted.

When the digital display reaches 8 seconds, an audible beep is emitted and the LEDs continue to emit yellow light.

When the digital display reaches 5 seconds, an audible command “exit in 5 seconds” is emitted and the LEDs still emit yellow light.

When the digital display reaches 3 seconds, an audible beep is emitted and the LEDs continue to emit yellow light.

When the digital display reaches 0, an audible command “exit now” is emitted and the LEDs change to emit red light.

After the countdown reaches 0, an audible command “exit now” is emitted intermittently along with a continuous audible beeping, and the LEDs continue to emit red light.

It is understood that this is only one of the many different sequences or combinations that can be provided with the embodiments according to the present invention. As discussed above, emitters or light sources can be provided that can emit different colors, as well as images or messages. Therefore, the LEDs in the previous example can emit not only red, yellow, and green light, but also any other colored light in the visible spectrum. Furthermore, the audible signal can emit many different types of commands, beeps, sirens, and/or alarms.

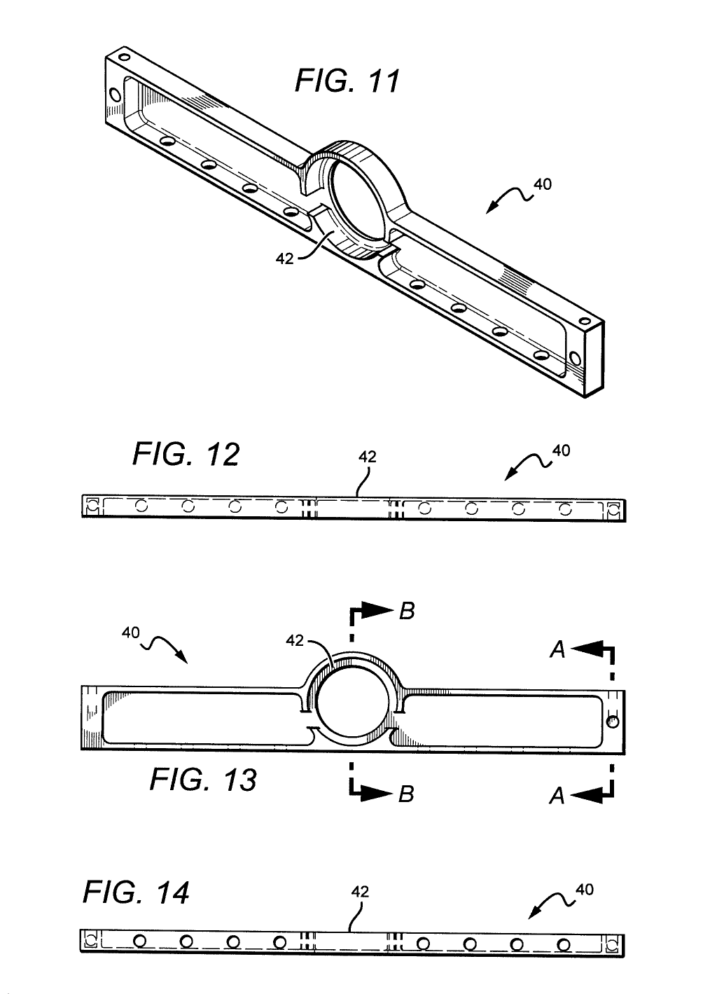

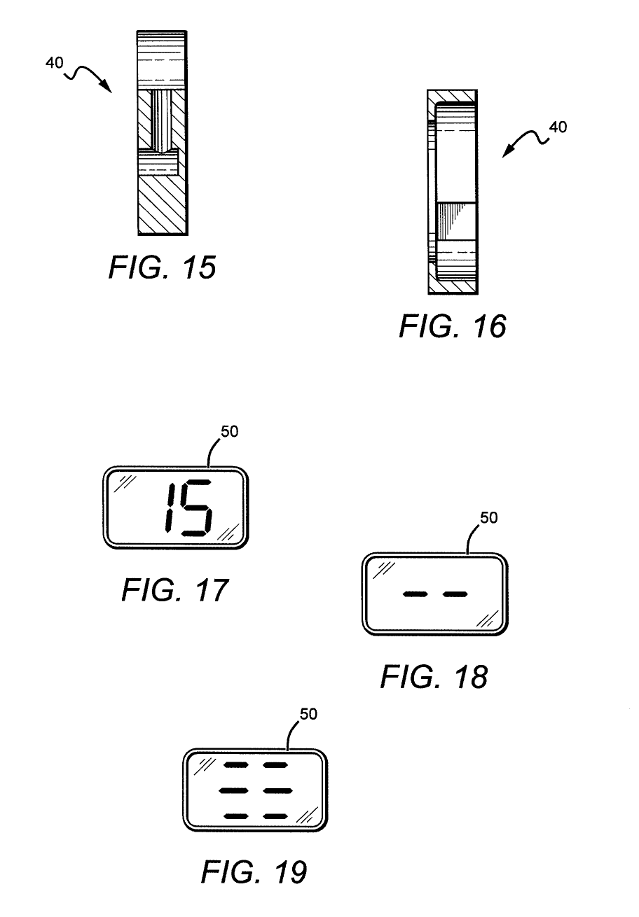

The lighting system housings according to the present invention can take many different shapes and sizes. FIGS. 11-16 show another embodiment of a lighting system housing 40 according to the present invention that is similar to the housing 10 shown in FIGS. 1-6 and described above. FIG. 11 is a perspective view of a lighting system housing 40 according to the present invention. FIG. 12 is a first side view of the lighting system housing 40. FIG. 13 is a top view of the lighting system housing. Also, FIG. 14 is a second side view of the lighting system housing 40. FIG. 15 is a sectional view of the lighting system housing 40, taken along section lines A-A of FIG. 13. FIG. 16 is another sectional view of the lighting system housing 40, taken along section lines B-B of FIG. 13. In the embodiment of FIGS. 11-16, the width of the housing 40 is smaller than the diameter of the opening 42, with the remainder of the housing 40 being substantially the same. Typical dimensions for the housing are about 10-11 inches long and about 1-2 inches in width. However, it is understood that the dimensions of the housing or housing features are not so limited and can be smaller or larger.

The present invention can also comprise different indicators to show if the locking device has been actuated and/or if the door was opened at the conclusion of the delayed egress sequence. This can include various combinations of light emitted by the LEDs in the lighting systems. In other embodiments, the digital display on the locking device can reflect if the door was opened.

FIGS. 17-19 are some examples of displays that indicate the present condition of the locking device and the door. FIG. 17 shows one embodiment of a digital display 50 which can be used within embodiments of the present invention displaying the number 15, which can reflect that the door is secured and locked. This can be the normal state of the locking device and digital display when the delayed egress sequence has not been initiated. As stated above, the number 15 can represent seconds, which is one example of the time interval countdown from when the locking device is actuated until egress is permitted. As displayed in FIG. 17, when the number 15 is shown on the digital display 50, it can represent that the locking device has not yet been actuated and the door is secure.

FIG. 18 displays the same digital display 50 at the end of the delayed egress sequence, after the countdown of the time interval has expired. The digital display of FIG. 18 can indicate that the locking device is unlocked, but the door has not been opened. FIG. 19 can show the same display 50 after the countdown has expired, at the end of the egress sequence, and when the door has been opened. These different displays help show condition of the locking device and the door at the end of the egress sequence. Additionally, these displays can help to indicate whether a person has actually passed through the door. As such, the display can show whether egress is not allowed, egress is allowed but not accomplished, and/or egress is allowed and accomplished.

Although FIGS. 17-19 display specific examples of indicators, it is understood that many other examples can be used in the present invention. For example, the digital display 50 can indicate a solid light pattern, a flashing light pattern, and/or a number of other light patterns. As previously stated, the digital display 50 can indicate the condition of the locking device and also whether the door is secure. The locking device can include the digital display 50, as well as an audible signal. The digital display can work along with the audible signal to create both a visual and audio warning, or the digital display and audible signal can exist separately on the locking device.

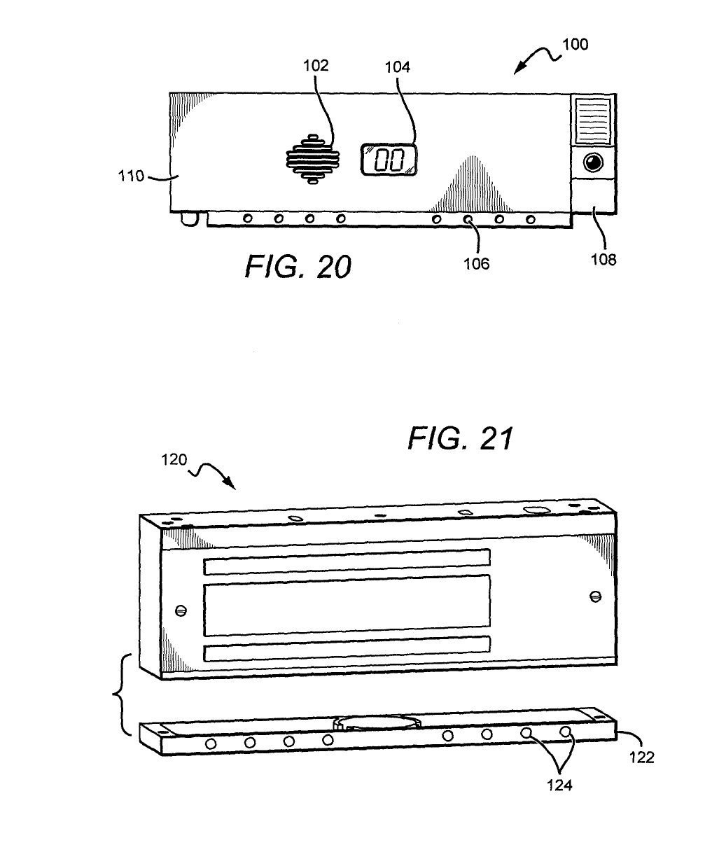

FIG. 20 is a front view of another embodiment of a locking device 100 with a lighting system incorporating features of the present invention. The locking device 100 can comprise an audio source 102, a visual display 104, one or more light sources 106, a camera 108, and a housing 110. As stated previously, the visual display 104 can help to display when the locking device will permit egress. Additionally, the visual display 104, the audio source 102, and/or the light sources 106 can all help to indicate the present condition of the locking device 100 and/or any door that the locking device is attached to and monitoring. Because there are many aspects of the locking device 100 which all pertain to security, the locking device can also be referred to as a security system.

Like other locking devices according to the present invention, the locking device 100 can signal forced entry or unauthorized exit. The locking device 100 can have built-in sensors that will activate a local and/or remote alarm upon attempted forced entry before the door and/or locking device has been compromised. The locking device 100 can be used at many types of facilities, including but not limited to, airports, health care facilities, commercial buildings, government centers, office complexes, museums and galleries, industrial complexes, retail establishments, and/or any type of facility where a delayed egress locking device can be of use. Some typical applications are delayed egress, alarmed exits, mantraps, cleanrooms, bathrooms, and/or any other type of room or door that requires monitoring. The mounting options for the locking device 100 can be a frame mount, where the device can vertically or horizontally face a side jamb or header, a wall mount, where the device is vertically or horizontally adjacent to a door or the top of an opening, as well as a ceiling mount. The locking device 100 can also compliment other similar products, such as magnetic locks, electrified locks, electric strikes, delayed egress devices, alarm devices, intruder devices, and/or any other device that can prevent a forced entry.

In FIG. 20, the camera 108 is shown on the right side of the housing 110. However, the camera 108 can be in many alternative locations. For example, the camera 108 can be in the housing 110, on the left side of the housing 110, in the visual display 104, in the one or more light sources, in the audio source 102, or in any additional location in and/or on the locking device 100. Furthermore, the camera 108 can be in a location that is remote from the locking device 100. By being in a remote location, the camera can monitor the activity at a desired location that is not adjacent to the locking device.

FIG. 21 displays an annunciation bar 120 for a locking device according to the present invention. The annunciation bar 120 can upgrade existing delayed egress and standard locks, as well as many other electromagnetic locks. The annunciation bar 120 can be highly visible from any angle. Furthermore, the annunciation bar 120 can comprise an illumination device 122, which can comprise light sources 124. These light sources 124 can have steady, flashing, and/or rolling signals, and can emit light of a variety of different colors. Also, the annunciation bar 120 can be suitable for retrofit or new construction locking devices, it can have a low voltage, and it can provide for easy installation. The status of a door can be indicated by a red, green, blue, and/or any other colored light panel. Additionally, the annunciation bar 120 can have an optional motion detector and/or camera.

The present invention can also comprise a visual and/or audio warning system at a remote location. This location can be remote from the locking device, so that there can be multiple locations that indicate the condition of the locking device and/or the door. By having remote indicator locations, those who are monitoring the security of multiple doors can be at a central location. As such, having indicators at multiple locations can help to ease the process of monitoring the security of the locking device and/or the door. For example, this remote location can be at a security desk, but it is understood that the remote locations are not limited to a specific type of location.

Moreover, a variety of devices can be configured to communicate whether the locking device has been actuated and/or if the door is secure. For example, the locking device can include communication components to transmit information to other devices concerning the condition of the locking device and/or door. In some embodiments, information can be transmitted to a location remote from the locking device. In other embodiments, information can be transmitted to another device, such as a mobile device. One example of a mobile device that can receive information is a cell phone, but it is understood that many other devices can be used to receive and/or transmit information from the locking device.

As mentioned above, the improved lighting and indicator systems according to the present invention can be used with many different locking devices and/or electric delayed egress devices as described above. For example, the lighting and indicator systems can be used with magnetic or electric locking devices such as the Emlock® 1500 Magnetic Lock models (e.g. 1510 Series, 1570 Series, 1580 Series) provided by Security Door Controls, Inc. It is understood that these are only some of the many locks that can use the lighting systems according to the present invention.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

We claim:

1. A security system, comprising:
a locking device for securing a door, said locking device delaying egress through said door for a predetermined time interval once said locking device is actuated;
a timing device connected to said locking device, wherein said timing device indicates a period of said time interval once said locking device is actuated; and
an illumination system connected to said locking device, wherein said illumination system comprises a series of light sources that signal actuation of said locking device.

2. The security system of claim 1, wherein said illumination system is connected to said timing device.

3. The security system of claim 2, wherein said illumination system displays the period of said time interval.

4. The security system of claim 2, wherein said illumination system displays whether egress is not allowed, egress is allowed but not accomplished, or egress is allowed and accomplished.

5. The security system of claim 1, further comprising:
an audio system connected to said locking device, wherein said audio system comprises a series of audible sources that signal when said locking device is actuated.

6. The security system of claim 5, wherein said audible sources comprise a speaker.

7. The security system of claim 1, wherein said locking device comprises a magnetic locking device.

8. The security system of claim 1, further comprising:
a switch connected to said locking device, wherein said switch sends a signal to said timing device and said illumination system when said locking device is actuated.

9. The security system of claim 1, wherein said light sources can comprise lights displaying different colors throughout said time interval.

10. The security system of claim 1, wherein said light sources comprise light emitting diodes (LEDs).

11. The security system of claim 1, wherein said light sources comprise a liquid crystal display (LCD) panel.

12. The security system of claim 1, wherein said illumination system illuminates an area around said door.

13. The security system of claim 1, further comprising a housing for said locking device.

14. The security system of claim 13, wherein said housing comprises compartments to hold said light sources.

15. The security system of claim 1, further comprising a camera to monitor an area around said door.

16. The security system of claim 15, wherein said camera is remote from said locking device.

17. The security system of claim 1, further comprising an indicator to determine if said door was opened during or at the conclusion of said time interval.

18. The security system of claim 1, further comprising a transmitter, wherein said transmitter can transmit information concerning the status of said locking device and said door.

19. The security system of claim 18, wherein said information can be transmitted to a location remote from said locking device and said door.

20. The security system of claim 18, wherein said information can be transmitted to a mobile device.
